(19) United States
(12) Patent Application Publication
(10) Pub. No.: US 2004/0167892 A1
(43) Pub. Date: Aug. 26, 2004

(54) Apparatus and method for translating between different role-based vocabularies for multiple users

(76) Inventors: Evan Kirshenbaum, Mountain View, CA (US); Mark Sabiers, Fort Collins, CO (US); Mathias Salle, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/372,126

(22) Filed: Feb. 25, 2003

(51) Int. Cl. G06F 17/30

(52) U.S. Cl. 707/4

(57) ABSTRACT

A method and corresponding apparatus use a translation system and vocabulary models to translate between different role-based vocabularies for different users. The vocabulary models may be associated with different roles, each role having one or more vocabularies. The vocabulary models may be fixed and hard-coded so that the roles and the role-based vocabularies are predefined and cannot be altered. The vocabulary models may also be flexible, allowing new roles and/or role-based vocabularies to be added.

### TECHNICAL FIELD

The technical field relates to computer systems, and, in particular, to systems that monitor operations of other systems.

### BACKGROUND

System status data, i.e., data related to state or performance of a system, or other types of system data may be presented to users with different backgrounds. The users may have different mental models of the meaning of a particular piece of data. In other words, the users may use different terminologies or vocabularies when describing the same piece of data. For example, in a web-based commerce system, a business manager may view the system in terms of demand and wasted resource, while an information technology (IT) manager may view the same system in terms of load and utilization. Therefore, the business manager may be concerned with how much money the business can make for a particular month. Providing the business manager with IT information, such as having an average of 5,000 computer sessions a day, is not particularly helpful. Similarly, for the IT manager who is concerned with actually providing computer support for the computer sessions, business data such as sales are up 20% is not as useful either. Therefore, with different mental models, it may be difficult to facilitate effective communication between different users.

### SUMMARY

A method for translating between different role-based vocabularies includes enabling a user to assert a first role associated with a first vocabulary model. The first role includes a first role-based vocabulary. The method further includes identifying the first role asserted by the user and enabling the user to select a second role. The second role is associated with a second vocabulary model and includes a second role-based vocabulary. The user constructs a query directed to the second role in the first role-base vocabulary. The method further includes using the first and the second vocabulary models to translate the query into the second role-based vocabulary corresponding to the second role.

A corresponding apparatus for translating between different role-based vocabularies includes vocabulary models that are associated with a plurality of roles. A user asserts a first role and constructs a query. The first role contains a first role-based vocabulary. The apparatus further includes a mapping module that identifies the first role asserted by the user and maps the query with the first role-based vocabulary corresponding to the first role, and a translation module that translates the query into a second role-based vocabulary corresponding to a second role. The second role provides a response to the query for the user.

### DESCRIPTION OF THE DRAWINGS

The preferred embodiments of the method and apparatus for translating between different role-based vocabularies will be described in detail with reference to the following figures, in which like numerals refer to like elements, and wherein:

FIG. 1 illustrates an exemplary infrastructure of a translation system for translating between different role-based vocabularies for different users;

FIG. 2 is a flow chart illustrating an exemplary operation of the translation system of FIG. 1;

FIG. 3A is a flow chart illustrating how the exemplary translation system uses a monitoring system and automatically translates system data for users asserting different roles;

FIG. 3B is a flow chart illustrating how the exemplary translation system conducts person-to-person communication for multiple users asserting different roles; and

FIG. 4 illustrates exemplary hardware components of a computer that may be used in connection with the method for translating between different role-based vocabularies.

### DETAILED DESCRIPTION

A method and corresponding apparatus use a translation system and vocabulary models to translate between different role-based vocabularies for different users. The vocabulary models may be associated with different roles, each role having one or more vocabularies. For example, a business manager may assert a role whose vocabulary contains terms such as “demand” and “customers,” while an IT manager may assert a role whose vocabulary contains terms such as “load,” “web sessions,” and “servers.” The vocabulary models may be fixed and hard-coded so that the roles and the role-based vocabularies are predefined and cannot be altered. The vocabulary models may also be flexible, allowing new roles and/or role-based vocabularies to be added.

Using the translation system, a user may view system data and/or queries from one or more other perspectives, enabling the user to better understand the system data and/or queries. The user may also automatically communicate with another user in the other user's vocabulary, without having to become an expert in another domain. For example, a question from an IT manager to a business manager, such as “please explain an increase in requests for a particular page last week,” may be automatically translated into “please explain an increase in inquiries on a particular product following the launching of a global advertising campaign” for the business manager. After the translation, the answer to the IT manager's original question may become apparent, and the inquiry is no longer necessary. As a result of the automatic translation, the IT manager can better understand the business aspect of the information without having to query the business manager.

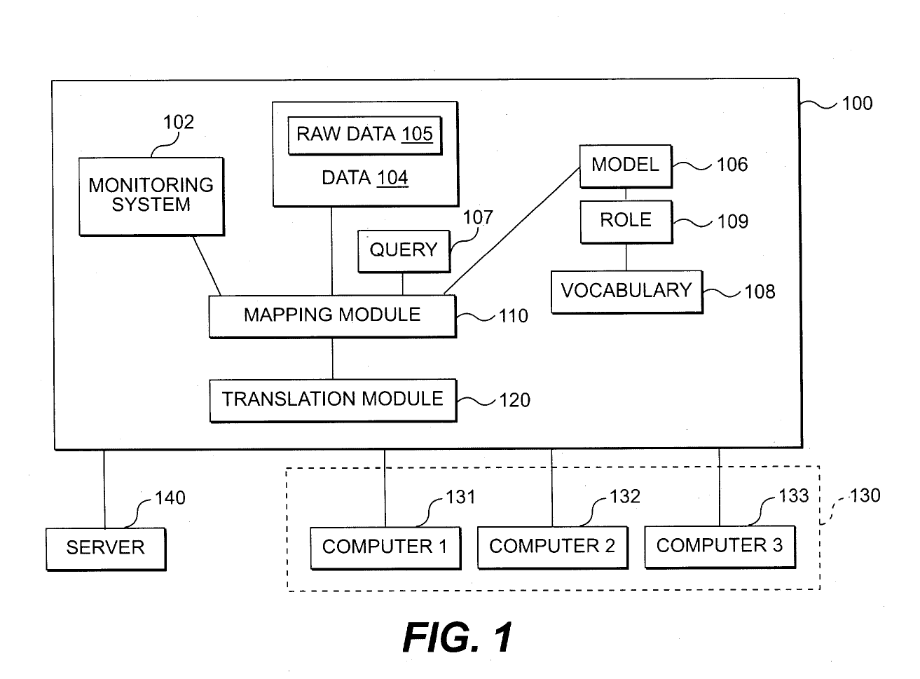

FIG. 1 illustrates an exemplary infrastructure of a translation system 100 for translating between different role-based vocabularies 108 for different users. The system 100 may include a monitoring system 102 that collects data 104 from a system being monitored and stores the collected data 104 in, for example, a database for collected data. The system being monitored may be, for example, an e-commerce web site, a traffic report in a city, or a sales report of computers in a company. The data 104 may also be responses to queries 107 or any other statements a user is interested in.

The translation system 100 may include different vocabulary models 106 that are associated with different roles 109. Each role 109 may have one or more role-based vocabularies 108. The monitoring system 102 typically stores the collected data 104 in a raw format, which is typically in a data collector's vocabulary 108. The data collector typically stores data in terms of actual events that are noticed and recorded. Other users may assert different roles 109 to access the collected data 104 using the translation system 100. Alternatively, the monitoring system 102 may store the collected data 104, such as a computer sales report, in a vocabulary of the most frequent user, a business manager, for example.

The translation system 100 further includes a mapping module 110 and a translation module 120. As noted above, each role 109 may be associated with a vocabulary model 106. For each user asserting a particular role 109, the mapping module 110 may use the associated vocabulary model 106 to map a query, a response to the query, or a statement with the user's role-based vocabulary 108. For example, an IT manager may be interested in the computer sales report prepared by the business manager. The IT manager and the business manager, asserting different roles 109, may use different vocabularies 108. The mapping module 110 may map the IT manager's query 107 with the IT manager's role-based vocabulary 108.

The data 104 may include multiple pieces of data components. For each data component, the translation module 120 may use mathematical expressions, computer programs or algorithms to translate the data component into another role-based vocabulary 108 based on the role 109 asserted by the user. For example, the translation module 120 may translate each component of the computer sales report to the IT manager's role-based vocabulary 108.

For example, after a user logs in and asserts a role 109 associated with a vocabulary model 106, the user typically selects a recipient and constructs a query 107 in the user's role-based vocabulary 108. The translation system 100 may use the mapping module 110 to map the query 107 with the user's role-based vocabulary 108. Next, the translation system 100 may use the translation module 120 to translate each data component of the query 107 into the recipient's role-based vocabulary 108. After the recipient provides a response, the translation system 100 may also translate each data component of the response to the user's role-based vocabulary 108.

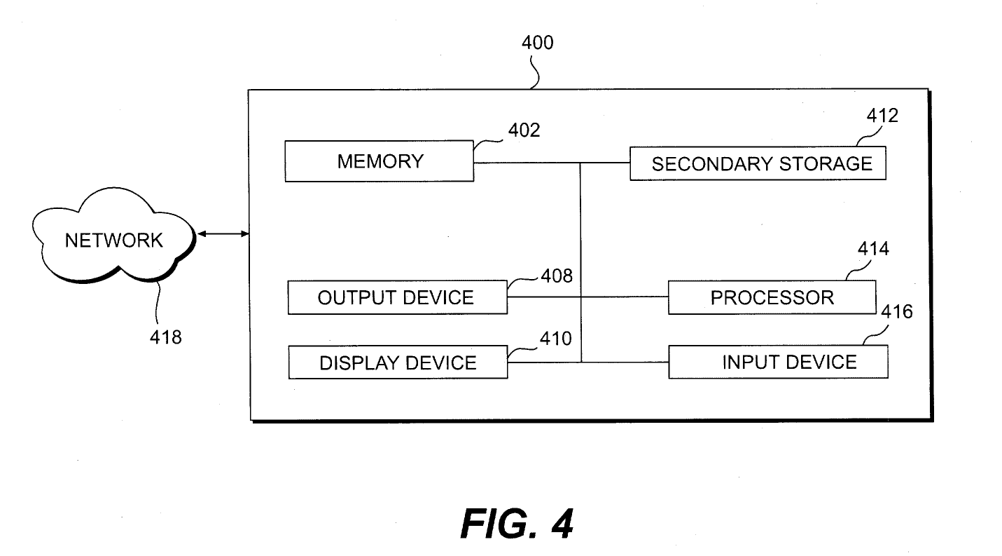

The translation system 100 may reside on a remote server 140. Alternatively, the system 100 may reside on local computers 130, such as computer 1 (131), computer 2 (132) and computer 3 (133), used by the various users. Each user may use a local computer 131, 132, 133 to communicate with the translation system 100 and with other users. The computers 130 may be connected to each other and to the server 140 through a network (shown in FIG. 4).

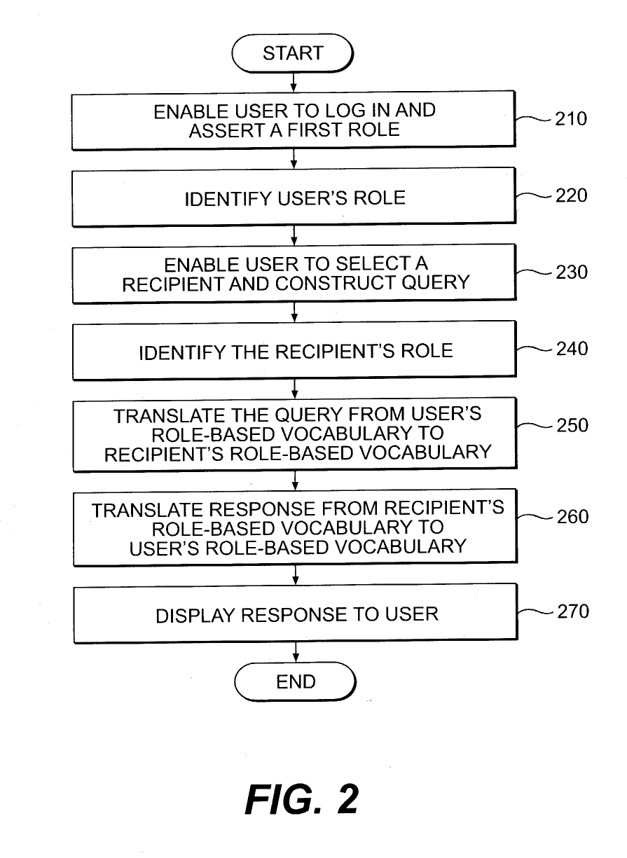

FIG. 2 is a flow chart illustrating an exemplary operation of the translation system 100. First, the translation system 100 enables a user to log in and to assert a first role 109 (block 210). The first role 109 may be associated with a vocabulary model 106, and may contain one or more role-based vocabularies 108 that the user is familiar with. The translation system 100 identifies the user's role 109 (block 220), and then enables the user to select a recipient and to construct a query 107 in the user's role-based vocabulary (block 230). After identifying the recipient's role 109 (block 240), the translation system 100 may use the vocabulary model 106 to map the query 107 with the user's role-based vocabulary 108, and to translate the query 107 from the user's role-based vocabulary 108 to the recipient's role-based vocabulary 108 (block 250). After the recipient provides a response to the user's query 107, the translation system 100 may use the vocabulary model 106 to translate the response from the recipient's role-based vocabulary 108 to the user's role-based vocabulary 108 (block 260). The translated response is then displayed to the user (block 270).

The recipient of the query 107 may be a monitoring system 102 that observes in real time a system being monitored. The response provided by the monitoring system 102 may be system status data, which is automatically translated to the user's vocabulary 108 to facilitate communication between the user and the monitoring system 102. Alternatively, the recipient of the query 107 may be another user of the translation system 100, and the translation system 100 facilitates person-to-person communication for users asserting different roles 109. One skilled in the art will appreciate that the translation system 100 may be used to facilitate other types of communication.

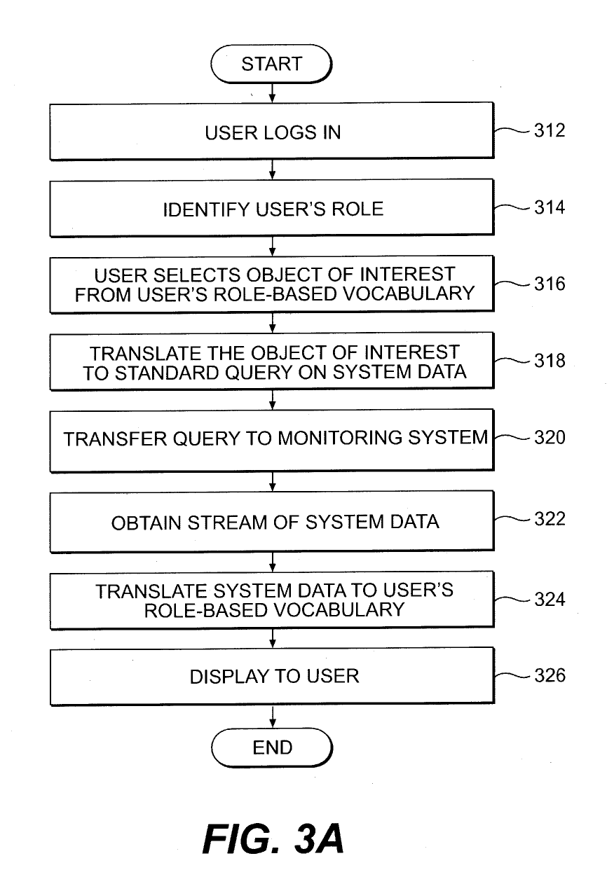

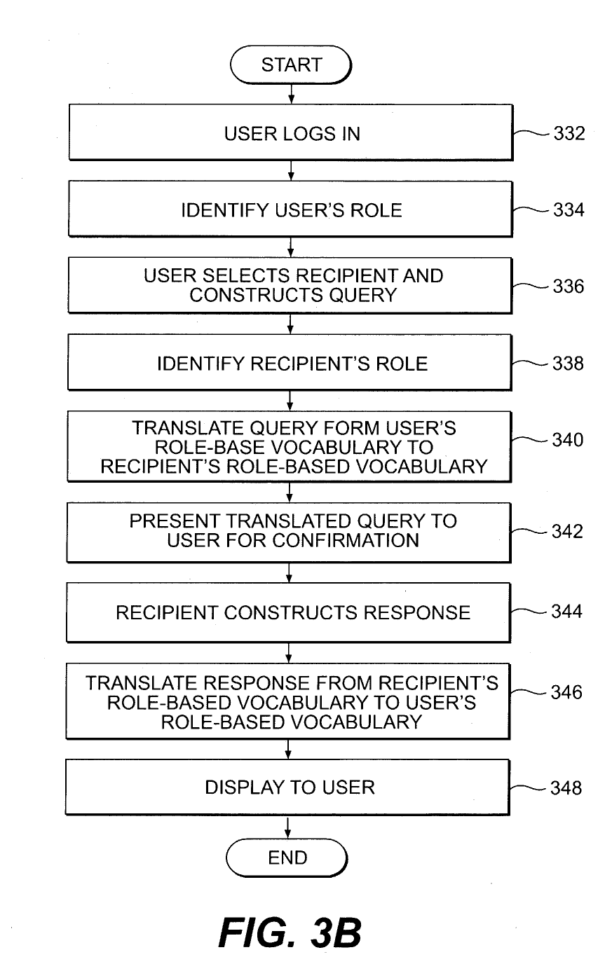

FIG. 3A is a flow chart illustrating how the exemplary translation system 100 uses a monitoring system 102 and automatically translates system data 104 for users asserting different roles 109. A user logs in (block 312) and identifies the user's role 109 to the translation system 100 (block 314). Each role 109 may be associated with a vocabulary model 106 and may contain one or more role-based vocabularies 108. Next, the user selects an object of interest from the user's role-based vocabulary 108 (block 316). The objects of interest may be a query 107 for the system status data 104 that the user is interested in, for example, the increase in sales for a business manager, or the utilization of available computer equipments for an IT manager. The translation system 100 then uses the vocabulary model 106 that corresponds to the user's role 109 to translate the objects of interest (stated in the user's vocabulary 108) into a standardized query (block 318). Next, the translation system 100 transfers the standardized queries to the monitoring system 102 (block 320).

The monitoring system 102 may provide a stream of raw system data 105 responding to the standardized query as the raw system data 105 changes over time (block 322). Finally, the translation system 100 may use the vocabulary model 106 to translate the raw system data 105 corresponding to the standardized query into the user's vocabulary 108 (block 324). The translated data 104 in the user's vocabulary is then displayed to the user (block 326). The translating steps (blocks 318 and 324) may be performed either on a remote server 140 or a local computer 130.

FIG. 3B is a flow chart illustrating how the exemplary translation system 100 conducts person-to-person communication for users asserting different roles 109. A user logs in (block 332) and identifies the user's role 109 to the system 100 (block 334). Similarly, each role 109 may be associated with a vocabulary model 106 and may contain one or more role-based vocabularies 108. The user then selects a recipient acting in a different role 109 and constructs a query 107 in the user's role-based vocabulary 108 (block 336). After the user submits the query, the translation system 100 identifies the recipient's role 109 (block 338), and uses the vocabulary models 106 corresponding to the user's role 109 and the recipient's role 109 to translate the query 107 (stated in the user's vocabulary) into the recipient's vocabulary 108 (block 340).

The translation system 100 may optionally present the translated query back to the user for confirmation (block 342). If the answer to the query 107 becomes apparent after translation, the user may decide not to send the query 107. After confirming that the user still desires to send the query, the translation system 100 may present the translated query to the recipient (block 342). The recipient then constructs a response to the query in the recipient's vocabulary 108 (block 344), and submits the response to the translation system 100. The translation system 100 may use the vocabulary models 106 to translate the response into the user's vocabulary 108 (block 346). The translated response in the user's vocabulary 108 is then displayed to the user (block 348).

FIG. 4 illustrates exemplary hardware components of a computer 400 that may be used in connection with the method for translating between different role-based vocabularies. The computer 400 includes a connection with a network 418 such as the Internet or other type of computer, telephone or wireless network. The computer 400 typically includes a memory 402, a secondary storage device 412, a processor 414, an input device 416, a display device 410, and an output device 408.

The memory 402 may include random access memory (RAM) or similar types of memory. The secondary storage device 412 may include a hard disk drive, floppy disk drive, CD-ROM drive, or other types of non-volatile data storage, and may correspond with various databases or other resources. The processor 414 may execute information stored in the memory 402, the secondary storage 412, or received from the Internet or other network 418. The input device 416 may include any device for entering data into the computer 400, such as a keyboard, keypad, cursor-control device, touch-screen (possibly with a stylus), or microphone. The display device 410 may include any type of device for presenting visual image, such as, for example, a computer monitor, flat-screen display, or display panel. The output device 408 may include any type of device for presenting data in hard copy format, such as a printer, and other types of output devices including speakers or any device for providing data in audio form. The computer 400 can possibly include multiple input devices, output devices, and display devices.

Although the computer 400 is depicted with various components, one skilled in the art will appreciate that the computer 400 can contain additional or different components. In addition, although aspects of an implementation consistent with the method for translating between different role-based vocabularies are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 400 to perform a particular method.

While the method and apparatus for translating between different role-based vocabularies have been described in connection with an exemplary embodiment, those skilled in the art will understand that many modifications in light of these teachings are possible, and this application is intended to cover any variations thereof.

What is claimed is:

1. A method for translating between different role-based vocabularies, comprising:
enabling a user to assert a first role associated with a first vocabulary model, wherein the first role includes a first role-based vocabulary;
identifying the first role asserted by the user;
enabling the user to select a second role, wherein the second role is associated with a second vocabulary model and includes a second role-based vocabulary;
enabling the user to construct a query directed to the second role, wherein the query is constructed in the first role-base vocabulary; and
using the first and the second vocabulary models, translating the query into the second role-based vocabulary corresponding to the second role.

2. The method of claim 1, wherein the second role provides data to the user, further comprising translating the data into the first role-based vocabulary corresponding to the first role asserted by the user.

3. The method of claim 2, further comprising displaying the data to the user in the first role-based vocabulary.

4. The method of claim 2, further comprising obtaining a stream of data to be translated.

5. The method of claim 2, wherein the second role provides system status data to the user.

6. The method of claim 1, wherein the enabling the user to select step includes enabling the user to select a monitoring system, and wherein the translating step includes translating the query into a standard query used by the monitoring system.

7. The method of claim 1, further comprising enabling the user to select an object of interest from the first role-based vocabulary.

8. The method of claim 1, further comprising:
enabling the user to construct a message to be sent to a second user, wherein the second user asserts the second role;
identifying the second role asserted by the second user; and
translating the message into the second role-based vocabulary corresponding to the second role.

9. The method of claim 8, further comprising enabling the second user to construct a response to the message in the second role-based vocabulary.

10. The method of claim 9, further comprising translating the response into the first role-based vocabulary corresponding to the first role asserted by the user.

11. The method of claim 8, further comprising presenting a translated message to the user for confirmation.

12. An apparatus for translating between different role-based vocabularies, comprising:
vocabulary models that are associated with a plurality of roles, wherein a user asserts a first role and constructs a query, and wherein the first role includes a first role-based vocabulary;
a mapping module that identifies the first role asserted by the user and maps the query with the first role-based vocabulary; and
a translation module that translates the query into a second role-based vocabulary corresponding to a second role, wherein the second role provides a response to the query for the user.

13. The apparatus of claim 12, wherein the translation module translates the query into a standard query used by a monitoring system, and wherein the monitoring system provides system status data.

14. The apparatus of claim 12, wherein the translation module translates the response into the first role-based vocabulary corresponding to the first role asserted by the user.

15. A computer readable medium providing instructions for translating between different role-based vocabularies, the instructions comprising:
enabling a user to assert a first role associated with a first vocabulary model, wherein the first role includes a first role-based vocabulary;
identifying the first role asserted by the user;
enabling the user to select a second role, wherein the second role is associated with a second vocabulary model and includes a second role-based vocabulary;
enabling the user to construct a query directed to the second role, wherein the query is constructed in the first role-base vocabulary; and
using the first and the second vocabulary models, translating the query into the second role-based vocabulary corresponding to the second role.

16. The computer readable medium of claim 15, wherein the second role provides data to the user, further comprising instructions for translating the data into the first role-based vocabulary corresponding to the first role asserted by the user.

17. The computer readable medium of claim 15, wherein the instruction for enabling the user to select include instructions for enabling the user to select a monitoring system, and wherein the instructions for translating include instructions for translating the query into a standard query used by the monitoring system.

18. The computer readable medium of claim 15, further comprising instructions for:
enabling the user to construct a message to be sent to a second user, wherein the second user asserts the second role;
identifying the second role asserted by the second user; and
translating the message into the second role-based vocabulary corresponding to the second role.

19. The computer readable medium of claim 18, further comprising instructions for enabling the second user to construct a response to the message in the second role-based vocabulary.

20. The computer readable medium of claim 19, further comprising instructions for translating the response into the first role-based vocabulary corresponding to the first role asserted by the user.
